(19) United States
(12) Patent Application Publication
(10) Pub. No.: US 2003/0104814 A1
(43) Pub. Date: Jun. 5, 2003

(54) Low latency mobile initiated tunneling handoff

(75) Inventors: Youngjune L. Gwon, Mountain View, CA (US); James Kempf, Mountain View, CA (US); Daichi Funato, San Jose, CA (US); Atsushi Takeshita, Sunnyvale, CA (US)

Correspondence Address: Brinks Hofer Gilson & Lione, P.O. Box 10395, Chicago, IL, 60610, US

(73) Assignee: DoCoMo Communications Laboratories USA

(21) Appl. No.: 10/138,389

(22) Filed: May 3, 2002

Related U.S. Application Data
(60) Provisional application No. 60/334,481, filed on Nov. 30, 2001.

(51) Int. Cl. H04Q 7/20

(52) U.S. Cl. 455/436; 455/435

(57) ABSTRACT

In the present invention, a tunnel is set up between two mobility serving nodes, source and target nodes. The tunnel is used for communication between a mobile node and the source node after the mobile node completes an L2 handoff from the source node to the target node but before completing the standard Mobile IP L3 registration process or undergoing IP routing update with the target node. The tunnel may be set up either before or after the mobile node completes the L2 handoff from the source node to the target node. Also, the tunnel may be set up by a trigger that is generated either externally or internally of the mobile node.

This application claims the benefit of U.S. Provisional Application No. 60/334,481, filed Nov. 30, 2001, and titled “Low Latency Mobile Triggered Post Registration Tunneling Handoff Scheme for Mobile IPv4 and Mobile IPv6,” which is incorporated herein by reference.

### FIELD OF THE INVENTION

This invention relates generally to the communication of digital data in digital data networks and more specifically to communication of digital data in wireless, mobile-access, Internet protocol-based data networks. This invention is particularly relevant to real-time interactive digital data communications such as voice over Internet protocol (VoIP) and real time interactive multi-media.

### BACKGROUND OF THE INVENTION

The need for personal wireless communications is expanding rapidly with the advances in digital communications and personal communications systems. The progress in cellular radio technology and the growth rate of the cellular telephone systems over the last several years is indicative of tremendous market demand for location independent communication via wireless access. Wireless or mobile cellular communications systems have evolved through generational changes since the first generation (1 G) wireless communications systems were first deployed commercially about two decades ago. The 1 G systems were entirely analog and primarily used for voice communication. Currently, the third generation (3 G) wireless communications systems are being introduced. The third generation (3 G) is defined by the ITU under the IMT-2000 global framework and is implemented by new communication technologies, such as W-CDMA and CDMA2000. 3 G is designed for high-speed multimedia data and voice, and its goals include high-quality audio and video and advanced global roaming, which means being able to go anywhere and automatically be handed off to whatever wireless system is available (in-house phone system, cellular, satellite, etc.). Unlike previous wireless communications systems, 3 G systems, depending on their system architectures, may be entirely IP based, i.e., all data is communicated in digital form via standard Internet addressing and routing protocols from end to end.

Most of the functionality in the OSI model also exists in wireless IP communication. The OSI multi-layer model defines 7-layer communication protocols. For example, the OSI model specifies a hierarchy of protocols including low level physical hardware specifications and connections (Layer 1), radio data link establishment and format (Layer 2), IP network addressing and routing (Layer 3) data transport rules (Layer 4), Session (Layer 5), Presentation (Layer 6) and Application (Layer 7). The Layer 2 is responsible for radio link between nodes and implements specific radio access technology. The Layer 3, which is sometimes referred to as the IP layer, performs routing of packets or IP datagrams.

Throughout evolution of wireless communications systems, technical challenges associated with implementing wireless communication have always been posed by a mobile node (MN), as traveling from one area to another, irregularly changing its point of attachment to terrestrial radio access point (AP) with which it is communicating wirelessly. Indeed, the most critical factor in achieving good performance for mobility protocols is the design of handoff. A handoff occurs when a MN moves from one radio AP to another. A mere change of radio AP is called a “Layer 2 (L2) handoff,” which does not involve any Layer 3 (L3) signaling at the IP level. If the new radio access point is associated with a new subnet, i.e., if the MN moves from one subnet to another, a changing in routing reachability occurs and requires Layer 3 (L3) protocol action. This L3 protocol action is called a “L3 handoff” and usually involves exchange of a series of IP messages that are used to update routing information for the MN to make sure that data destined to the MN is routed through the new subnet to the MN.

The Internet Engineering Task Force (IETF) has proposed several standards to deal with the handoff operations. For instance, IETF RFC 2002 titled “IP Mobility Support,” which is usually referred to as Mobile IP Version 4 (IPv4) and incorporated herein by reference, describes how a MN can perform L3 handoffs between subnets served by different agents. Under IPv4, a MN is given a long-term home address by its home agent (HA) and uses the home address as the source address of all IP data that it sends. When located on a foreign subnet away from its home subnet, a “care-of address” (CoA) is associated with the MN and reflects the MN's current point of attachment. Through an L3 handoff, the CoA is registered in the MN's home agent to enable the HA to update its binding or data-routing information for the MN.

The L3 handoff process pursuant to RFC 2002 requires mobility agents, i.e., foreign agents and home agents, to advertise their presence via Agent Advertisement messages. A MN that receives these Agent Advertisements determines whether it is operating on its home subnet or a foreign subnet. When the MN detects that it has entered a new subnet, it obtains a CoA from Agents Advertisements sent from the foreign agent serving the foreign network. The MN then registers the new CoA by sending a registration request including the CoA to its home agent (HA). The L3 handoff completes when the HA receiving the registration request updates its internal binding information for the MN and returns a registration reply to the MN. After the registration, data sent to the MN's home address are intercepted by the HA, tunneled by the same to the MN's CoA, received at the tunnel endpoint (either at a FA or at the MN itself), and finally delivered to the MN. In the reverse direction, data sent by the MN is generally delivered to its destination using standard IP routing mechanisms, not necessarily passing through the HA.

Mobile IP was originally designed without any assumptions about the underlying link layers over which it would operate so that it could have the widest possible applicability. This approach has the advantage of facilitating a clean separation between L2 and L3 of the protocol stack, but it has negative consequences. Because of the strict separation between L2 and L3, a MN may only communicate with a directly connected FA. This implies that a MN may not begin the registration process until it obtains L2 connectivity to a new FA after having lost L2 connectivity to the old or previous FA. In addition, the registration process itself takes some time to complete as the registration request and reply messages propagate through networks between the MN to its HA. The time from the last L3 connectivity between the MN and the old FA, to the time when the L3 connectivity to the new FA has been established manifests itself as handoff latency. During this time period, the MN is not able to send or receive any data. The handoff latency resulting from standard Mobile IP handoff procedures could be greater than what is acceptable to support real-time or delay sensitive traffic.

Several protocol designs have been proposed for both Mobile IPv4 and IPv6 that seek to reduce the amount of handoff latency. For instance, Internet Draft “Low Latency Handoffs in Mobile IPv4” <draft-ietf-mobileip-lowlatency-handoffs-v4-03.txt>, which is incorporated herein by reference, proposes two techniques for minimizing the period of time when a MN is unable to send or receive data due to the delay in the Mobile IP registration process. One such technique is “pre-registration handoff” which allows the MN to communicate with a new FA while still connected to the old FA. The other is called “post-registration handoff” which provides for data delivery to the MN at the new FA even before the formal registration process has completed. More specifically, under the pre-registration handoff method, the old FA, initiated by an L2 trigger, notifies the MN of a new FA. The MN then begins an L3 handoff with the new FA while still in communication with the old FA, i.e., while receiving and sending data through the old FA. In other words, the pre-registration handoff method allows the L3 handoff to begin even before the L2 handoff begins and thus helps achieve seamless handoffs between old and new FAs. The new FA may initiate the pre-registration handoff by sending its presence through the old FA to the MN. Also, the MN may become an initiator of the pre-registration handoff by sending a Proxy Router Solicitation to the old FA, which in return advises the MN of the new FA. In any event, a prompt and timely L2 trigger is necessary to implement the pre-registration handoff.

The post-registration handoff method allows the old FA and new FA to utilize L2 triggers to set up a bi-directional tunnel (BDT) between the old FA and new FA that allows the MN to continue using the old FA while on the new FA's subnet. The post-registration handoff is likewise initiated by an L2 trigger that is provided to either the old FA or the new FA. Following a successful Mobile IP Registration between the MN and the old FA, the old FA becomes the mobility anchor point for the MN. Either the old FA or the new FA then receives an L2 trigger informing that the MN is about to move from the old FA to the new FA. The FA (old or new FA) receiving the trigger sends a Handoff Request to the other FA (new or old FA), which returns a Handoff Reply, thereby creating a bidirectional tunnel between the FAs. When the link between old FA and MN is disconnected, the old FA begins forwarding MN-bound data through the tunnel to the new FA. When a new link is established between new FA and MN, the new FA begins delivering the data tunneled from the old FA to the MN and forwards any data from the MN through the reverse tunnel to the old FA. After the L2 handoff is completed, the MN may, while sending and receiving data through the tunnel from the new FA, perform a formal Mobile IP registration with the new FA. The initiation of this formal registration may be delayed. Thus, the post-registration handoff enables a rapid establishment of service at the new FA.

Internet Draft “Fast Handovers for Mobile Ipv6” <draft-ietf-mobileip-fast-mipv6-03.txt>, which is incorporated herein by reference, proposes similar techniques for minimizing the handoff latency for Mobile Ipv6.

In both pre and post-registration handoff methods, it is assumed that L2 triggers are properly fired at right timings. An L2 trigger is an abstraction of a notification from L2 that a certain event related to the L2 handoff process has happened or is about to happen. One possible event is early notice of an upcoming change in the L2 point of attachment of the MN. Other possible events are disconnection of the MN's point of attachment from the old L2 access point and establishment of the MN's point of attachment to a new L2 access point. Usually, firing of L2 triggers is assisted by a radio access network (RAN) or radio network controller (RNC) located in a subnetwork, which keeps track of and maintains location information of all the MNs situated within the subnetwork. Accordingly, prompt and timely firing of L2 triggers necessitates close collaboration of two neighboring RANs over which the MN is traveling. Since close collaboration by two RANs is possible only when they support the same radio access technology, the above assumption regarding the L2 trigger firing may practically be translated into an assumption that two neighboring RANs over which the MN is traveling support the same radio access technology. However, current trends in wireless networking suggest that future wireless networks will consist of a variety heterogeneous RANs that support different radio access technologies. The proposed pre and post-handoff protocols simply do not support such heterogeneous handoffs.

### BRIEF SUMMARY OF THE INVENTION

The present invention provides a tunneling handoff process that can minimize the handoff latency associated with the standard Mobile IP registration. The invention is applicable in both Mobile IPv4 and IPv6. Thus, in this application, the term “agent” used in Mobile IPv4 and the term “router” or “access router” used in Mobile IPv6 may be used interchangeably with each other or collectively referred to as “mobility serving nodes.”

The present invention contemplates a situation where a mobile node is leaving one subnet operated by one mobility serving node (source) and entering another subnet operated by another mobility serving node (target). In one embodiment according to the present invention, the mobile node, upon triggered, initiates the tunneling handoff process according to the present invention to establish a tunnel between the two mobility serving nodes, i.e., source and target nodes. After the mobile node has entered the new subnet operated by the target node, the standard Mobile IP registration process is delayed. Instead, the mobile node uses the tunnel to communicate with the source node while on the subnet operated by the target node. More specifically, in the present invention, the tunnel established between the source and target nodes will be used by the mobile node to communicate with the source node after the mobile node completes an L2 handoff from the source node to the target node but before completing an L3 handoff or undergoing IP routing update with the target node. The tunnel may be established either before or after the mobile node completes the L2 handoff between the source and target nodes.

In one embodiment, a mobile node is an entity that, upon triggered, performs initiation of the tunneling handoff process according to the present invention. The trigger is generated either externally or internally of the mobile node. Alternatively, the mobile node may use its internal L2 or L3 signaling to initiate the handoff process of the present invention. The mobile node can initiate the tunneling handoff scheme according the present invention irrespective of whether the source and target nodes support the same radio access technology or different radio access technologies.

In another embodiment, the mobile node, upon triggered, sends a tunneling handoff request to the source node to establish a tunnel before the mobile node initiates an L2 handoff from the source node to the target node. The mobile node obtains an L2 identifier, such as an L2 address, of the target node and includes the L2 identifier in the tunneling handoff request. The source node may in advance create a table containing L3 identifiers, such as L3 addresses or IP addresses, of neighboring networks in relation to their L2 identifiers and look up the table for the L3 identifier that corresponds to the L2 identifier in the tunneling handoff request from the mobile node. The mobile node may, if possible, obtain an L3 identifier of the target node and includes the L3 identifier in the tunneling handoff request.

Alternatively, the mobile node may send a tunneling handoff request to the target node to establish the tunnel after the mobile node completes an L2 handoff from the source node to the target node.

In another embodiment, in handoffs between source and target nodes that support different radio access technologies, any one of the mobile node, the source node and the target node may initiate the tunneling handoff process according to the present invention.

### BRIEF DESCRIPTION OF THE DRAWINGS

FIG. 1 is a graphical representation of a third generation wireless, mobile access, IP data network in which the present invention is intended to operate;

FIG. 2 is a simplified graphical representation of the standard Mobile IP registration process;

FIG. 3a is a graphical representation illustrating a Pre-L2 handoff Mobile Initiated Tunneling Handoff (Pre-MIT) for IPv4 according to an embodiment of the present invention;

FIG. 3b is a diagram illustrating trigger mode timing analysis for the Pre-MIT shown in FIG. 3a;

FIG. 3c is a diagram illustrating triggerless mode timing analysis for the Pre-MIT shown in FIG. 3a;

FIG. 4a is a graphical representation illustrating a Post-L2 handoff Mobile Initiated Tunneling Handoff (Post-MIT) for IPv4 according to another embodiment of the present invention;

FIG. 4b is a diagram illustrating trigger mode timing analysis for the Post-MIT shown in FIG. 4a;

FIG. 4c is a diagram illustrating triggerless mode timing analysis for the Post-MIT shown in FIG. 4a;

FIG. 5 is a graphical representation illustrating an agent solicitation message format used in an embodiment of the present invention;

FIG. 6 is a graphical representation illustrating an MIT request message format used in an embodiment of the present invention;

FIG. 7a is a graphical representation illustrating a Pre-MIT for IPv6 according to another embodiment of the present invention;

FIG. 7b is a diagram illustrating timing analysis for the Pre-MIT shown in FIG. 7a;

FIG. 8a is a graphical representation illustrating a Post-MIT for IPv6 according to another embodiment of the present invention;

FIG. 8b is a diagram illustrating timing analysis for the Post-MIT shown in FIG. 8a;

FIG. 9 is a graphical representation illustrating a mobile handoff initiation message format used in an embodiment of the present invention;

FIG. 10 is a graphical representation illustrating a source or target handoff initiation message format used in an embodiment of the present invention; and

FIG. 11 is a graphical representation illustrating a handoff acknowledgement message format used in an embodiment of the present invention.

### DETAILED DESCRIPTION OF THE INVENTION

The present preferred embodiments of the invention are described herein with references to the drawings, wherein like components are identified with the same references. The descriptions of the preferred embodiments contained herein are intended to be exemplary in nature and are not intended to limit the scope of the invention.

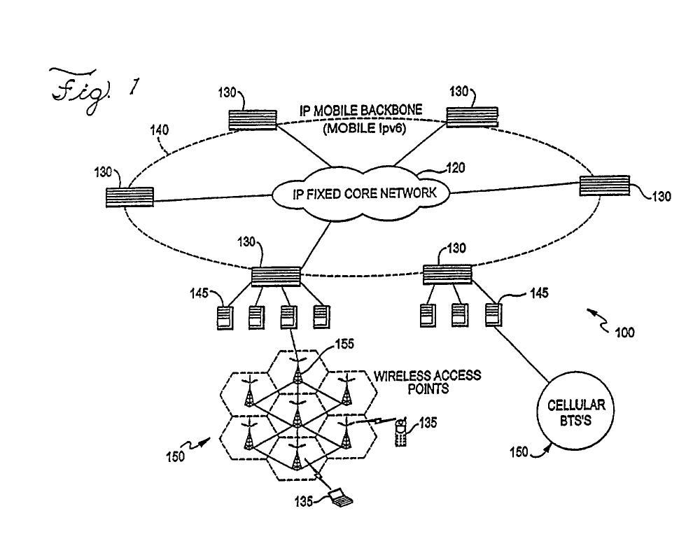

FIG. 1 illustrates graphically an exemplary third generation, wireless, mobile access, Internet protocol (IP) data network 100 in which the invention will find application. For purposes of the present application, it is assumed the IP data network 100 adheres to the International Mobile Telecommunications 2000 (IMT-2000) standards and the specification of the International Telecommunications Union (ITU) for wireless, mobile access networks. Additionally, it is assumed that the data network 100 implements Mobile IP support according to the proposed Mobile IP version 4 (IPv4) standard of the Internet Engineering task Force (IETF). However, those skilled in the art will appreciate that the present invention can also be used in data networks that implement the Mobile IPv6 protocols. Thus, it should be noted that throughout this application, the term “agent” may be used interchangeably with the term “access router” or just “router” and so may “Agent Discovery” with “Neighbor Discovery,” “Agent Solicitation” with “Router Solicitation” and “registration request” with “binding update.” Especially, the term “agent” and the term “router” or “access router” may be collectively referred to as “mobility serving node” in this application. The Mobile IPv6 protocols are prescribed in the draft working document <draft-ietf-mobileip-ipv6-13> entitled “Mobility Support in IPv6,” which is incorporated herein by reference.

The wireless, mobile access, IP data network 100 has at its core a fixed node IP data network 120 comprising numerous fixed nodes (not shown), i.e., fixed points of connection or links. Digital data is communicated within and over the network in accordance with Internet Protocol version 4 (IPv4), specified as IETF Requests for Comments (RFC) 2002, which is incorporated herein by reference. Again, IPv4 is just an example of communication protocol and can be replaced with other communication protocols, such as IPv6. Some of the nodes of the core network 120 comprise conventional routers (not shown), which function as intermediary nodes in accordance with conventional Internet addressing and routing protocols to route packets of data between source and destination nodes connected to the network.

Built on the core 120 is a collection of gateway routers (GR) 130 that comprise an IP mobile backbone 140. The gateways 130 comprising the IP mobile backbone are themselves nodes of the core network 120 and are interconnected via the core network 120. Each gateway 130 has a plurality of agents 145 connected thereto that can communicate with mobile nodes 135. Mobile nodes may comprise any number of different kinds of mobile, wireless communication devices including handsets, cellular telephones, hand-held computers, personal information managers or the like. The agents 145 are mobility serving nodes and function as home agents (HA) and foreign agents (FA) to interface mobile nodes 135 to the core network 120 through gateways 130, as specified in IETF RFC 2002. The agents 145 are Layer 3 access network entities. The mobile nodes 135 communicate with the agents 145 through radio access points (AP) 155. The APs 155 are Layer 2 access network entities. A group of APs 155 forms a subnetwork 150. Each agent 145 serves a subnetwork 150 and provides a network link as an interface between the subnetwork 150 and the data network 100. The mobile nodes 135 and the APs employ known CDMA or W-CDMA or similar digital data communication technology to communicate with each other.

Pursuant to RFC 2002, each mobile node is assigned a home radio subnetwork which comprises a home agent 145, which maintains current location information of the mobile node and which can route packets to the mobile node at its current location. Other agents 145 function as foreign agents, which a mobile node can “visit” while away from its home subnetwork area. Whichever home agent or foreign agent a mobile node 135 happens to be communicating with at a given time establishes a network link and provides network access to the mobile node. Each of the mobile nodes and agents in the network has a unique IP address just as in conventional fixed node data networks employing conventional Internet protocols.

Within the overall data network 100, two levels of handoff process are contemplated. The first level is a macro-level handoff or an Layer 3 handoff, which involves a change in location of a mobile node such that it leaves one radio subnetwork served by one agent to go to another subnetwork served by another agent. Thus, through an L3 handoff, the mobile node's network link necessarily changes. The next level is a micro-level handoff or an Layer 2 handoff, which involves a change in the location of a mobile node within an AP subnetwork 150, in which case the mobile node's radio link changes but network link does not change. The handling of L2 handoff is standard in wireless, cellular communication networks. For example, it is well known to use beacon signal strength from nearby APs for detecting reachability of the nearby APs.

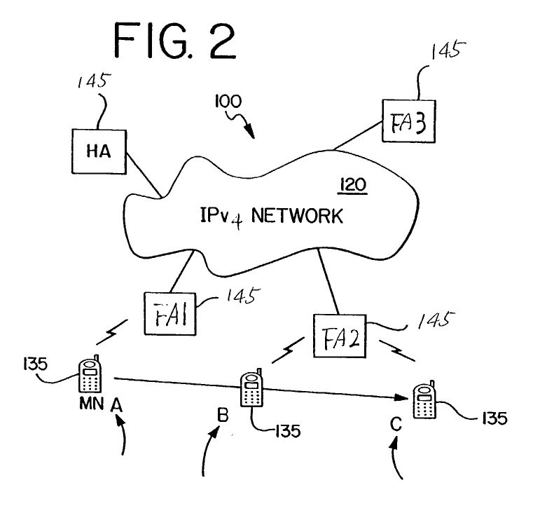

FIG. 2 provides a simplified graphical illustration of the standard Mobile IP L3 handoff process. The network 120 is an IP data network that implements IPv4. Connected through gateways (not shown) to the network 120 are mobility agents 145 (HA, FA1, FA2 and FA3), each of which, as described above, operates its own subnet 150 that consists of a group of APs 155 (not shown). Each subnet has a radio access network (RAN) or radio network controller (RNC) that keeps track of and maintains location information of all the MNs situated within its own subnet.

A MN 135 is currently located at a starting location A which is within the subnet operated by the FA1 and moving towards an end location C via an intermediary location B. The MN has originated from the HA and thus has a permanent home IP address given by the HA. But being within the FA1's subnet away from the HA's subnet, the MN has temporarily configured itself with a care-of address (CoA) provided by the FA1. Through the Mobile IP registration process that the MN previously performed with the FA1, the CoA has been registered in the HA as binding information. Therefore, any data that is destined to the MN is intercepted by the HA, tunneled to the FA1 and forwarded to the MN from the FA1. Outbound data from the MN may be routed back to the HA or sent directly to its destination.

As the MN moves from the starting location A and arrives at the intermediary location B, there comes a point where further wireless communication with the FA1 begins to fail. The MN is leaving the subnet 150 operated by the FA1 and about to enter the subnet 150 operated by the FA2. As the MN passes the intermediary location B, an L2 trigger is fired to inform the MN, FA1 and FA2 that the MN's L2 handoff is imminent. The trigger is fired sufficiently before the MN loses its radio link with the FA1 so that the MN can complete the L2 handoff to the FA2 before it loses the FA1. The L2 handoff is collaborative action by the MN, FA1 and FA2 and assisted by the RANs of FA1 and FA2. Upon completion of the L2 handoff, the MN has a new radio link with the subnet 150 operated by the FA2. Also, as soon as the MN enters the FA2's subnet, it begins to receive Agents Advertisements from the FA2. The Agents Advertisements from the FA2 inform the MN that it is now operating in the subnet served by the FA2.

As moving further towards the destination location C, the MN performs an L3 handoff or standard Mobile IP registration with the FA2. At the beginning of the registration process, the MN extracts a CoA from an Agent Advertisement from the FA2. Preferred procedures for address auto-configuration are specified in IETF RFC 2462, which is incorporated herein by reference. The MN's new CoA includes the FA2's IP address and a subnet address component for the MN as advertised by the FA2. The MN then registers the new CoA by sending, to the HA through the FA2, a registration request containing both the new CoA and the MN's permanent home IP address. In response, the HA updates the binding information of the MN in its binding cache and sends the MN a registration replay through the FA2, whereby an L3 link is established between MN and FA2. Hereafter, packets transmitted to the home IP address of the MN will be intercepted by the HA and tunneled by the HA to the FA2 and delivered to the MN from the FA2.

Please note that during the above standard Mobile IP registration process, there is a time period created during which the MN is unable to send or receive data. This time period is referred to as handoff latency, which starts at the time when the MN loses its radio communication with the FA1 and ends at the time when the MN completes the L3 handoff to the FA2. It has been calculated that the handoff latency introduced during the above registration process will probably fall in the range of more than hundreds of msecs. The contributing factors to this handoff latency appear to be the new agent discovery by the MN, the updating procedures at the HA, and probably most significantly, propagation of the registration request and replay messages between HA and FA2, which are likely to be separated by other intermediate local networks. The handoff latency resulting from the above standard Mobile IP registration process could be greater than what is acceptable to support real-time or delay sensitive traffic.

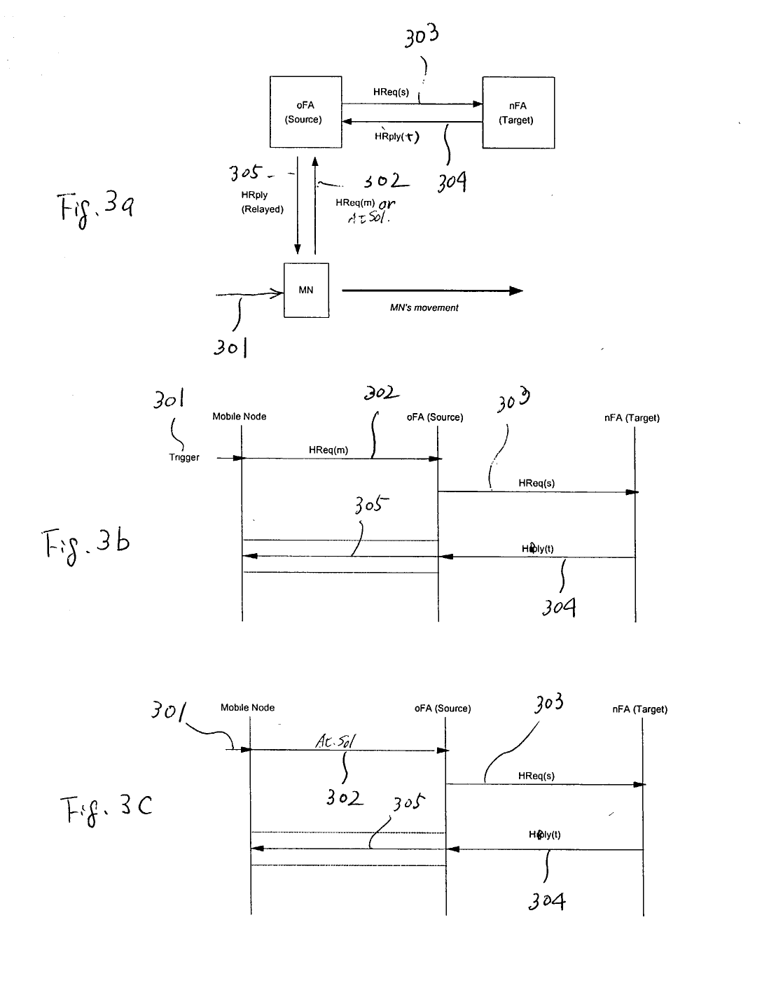

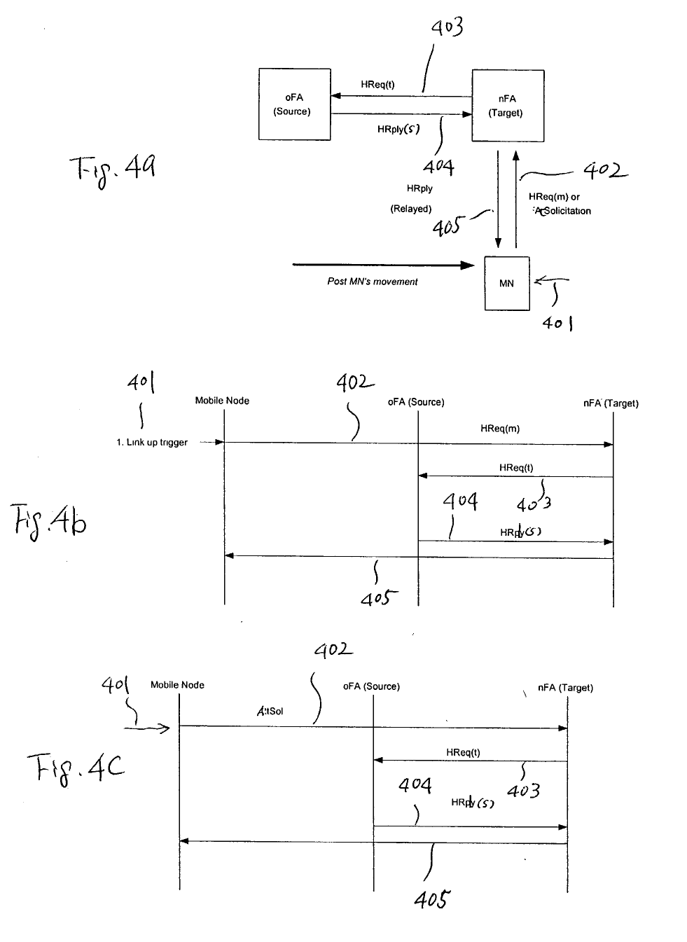

The present invention provides basically two schemes for minimizing latency associated with L3 handoffs. The first scheme is called a Pre-L2 handoff Mobile Initiated Tunneling handoff (Pre-MIT), and its detailed steps are illustrated in FIGS. 3a, 3b and 3c. The second scheme is called a Post-L2 handoff Mobile Initiated Tunneling (Post-MIT), and its detailed steps are illustrated in FIGS. 4a, 4b and 4c. Each scheme may operate under either trigger mode or trigger-less mode. With reference to FIGS. 3a, 3b and 3c, the Pre-MIT will first be described.

FIG. 3a is a graphical representation illustrating a Pre-MIT for IPv4. FIG. 3b is a diagram illustrating trigger mode timing analysis for a Pre-MIT shown in FIG. 3b. In FIG. 3a, there are two FAs shown each of which has, as described above, its own subnet 150 that consists of a group of APs 155 (not shown). A MN has been registered with an old FA (oFA or source) and is currently sending and receiving data through the oFA. The MN is now moving away from the oFA towards a new FA (nFA or target). It is assumed that the oFA and the nFA support different radio access technologies. This assumption will also underlie the other embodiments discussed in the present application. Yet, it should be appreciated that the present invention is also applicable to handoffs between FAs that support the same radio access technology.

When the MN arrives at a certain point between oFA and nFA where data communication with the oFA begins to fail, the MN receives an L2 trigger informing that an L2 handoff is imminent (Step 301). An L2 trigger is an abstraction of a notification from Layer 2 that a certain event has happened or is about to happen. There are three kinds of L2 triggers contemplated in the present invention. The first trigger is a trigger that notifies that an L2 handoff is imminent. This first trigger may be received by any of the MN, the oFA and the nFA. The second trigger is called a link-down trigger that notifies the MN and the oFA that they have lost an L2 communication link that existed between them. The last trigger is called a link-up trigger that notifies the MN and the nFA that a new L2 communication link has been established between them.

In the present invention, the L2 trigger is not associated with any specific L2 signals but rather is based on the kind of L2 information that is or could be available from a wide variety of radio link protocols. Thus, the trigger may be implemented in a variety of ways. For instance, the L2 driver may allow the IP stack to register a callback function that is called when the trigger fires. The operating system may allow a thread to call into a system call for the appropriate trigger or triggers. The trigger may consist of a protocol for transferring the trigger notification and parameter information at either L2 or L3 between the new AP and the old AP. Alternatively, the trigger information may be available within the operating system kernel to the IP stack from the driver as an out of band communication. Also, triggers may come from any of the oFA, the nFA and even the radio access networks (RAN) or radio network controllers (RNC) that serve the subnets operated by the oFA and the nFA if those entities are capable of firing such L2 triggers. The MN may self-trigger itself if it is capable of firing the triggers.

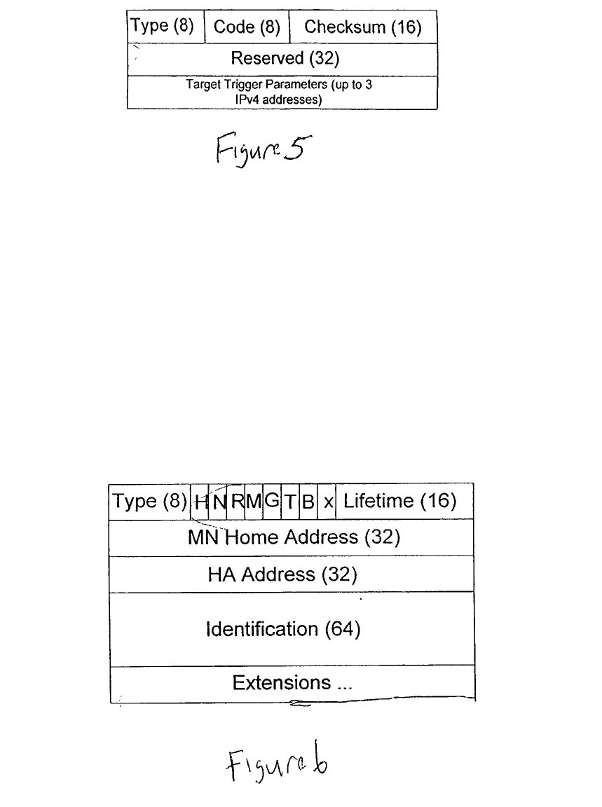

Triggered by the L2 trigger notifying that an L2 handoff is imminent, the MN sends a mobile handoff request (HReq(m)) to the oFA (Step 302). This HReq(m) is in a special message format that comprises an Internet Control Message Protocol (ICMP) Field, which contains four values, as shown in FIG. 5. The four values in the ICMP field are a type value, a code value, a checksum value and a reserved value. These values are in a bit format. The type value indicates that the message is a mobile handoff request (HReq(m)). The code value is 0. The checksum value is a 16-bit one's complement of the one's complement sum of the ICMP message, starting with the ICMP type value. For computing the checksum, the checksum field is set to 0. The reserved value is 32 bits that are set at 0.

The other field in the special message format is an Address field. The Address field contains target trigger parameters that are in a bit format. The target trigger parameters are link layer addresses or L2 identifiers (e.g., L2 addresses) of up to three target foreign agents. The MN may obtain these L2 identifiers from pilot beacon signals received from FAs. The oFA may optionally choose one of these L2 identifiers according to predetermined policies. In this embodiment, for better understanding of the processes in the invention, it is assumed that the Address field contains one address, i.e., the address of the nFA. It is also assumed that the oFA knows the IP address of nFA. Without the IP address of nFA, the oFA could not communicate directly with the nFA. There are two ways for the oFA to obtain the IP address of nFA. One way is to obtain it from the MN. If Agent Advertisements from the nFA reach the MN, the MN may obtain the IP address of nFA from the Agent Advertisements and attach the address to an HReq(m). The other way is to require the oFA to have a table caching IP addresses of nearby FAs in relation to their L2 identifiers. If there is no IP address attached to the HReq(m), the oFA will extract an L2 identifier from one of the extensions of the HReq(m). With this L2 identifier, the oFA searches the table to find the corresponding IP address. Formation of the table and its search operation will be discussed later in detail in the Pre-MIT triggerless mode scheme shown in FIG. 3c. It is assumed in this embodiment that an HReq(m) from the MN has extensions that contain both L2 and L3 identifiers of nFA.

When receiving the HReq(m) from the MN, the oFA extracts the L3 identifier stored in one of the extensions attached to the HReq(m) and determines that the MN is going to switch its point of attachment from itself to the nFA. The oFA then sends a Source Agent Handoff Request (HReq(s)) to the nFA (Step 303). When receiving the HReq(s) from the oFA, the new FA opens the extensions attached to the request and learns that the MN is about to handoff from oFA to itself. In response, the nFA sends a Handoff Reply (HRply(t)) back to the oFA (Step 304), whereby a tunnel is established between oFA and nFA. The tunnel may be unidirectional and used only to forward data from nFA to oFA. Alternatively, the tunnel may be bidirectional and used to forward data back and forth between oFA and nFA. The Handoff Reply from the nFA is forwarded by the oFA to the MN (step 305).

The HReq(s) and the HRply(t) are in a special message bit format identical to each other. FIG. 6 shows the message format of the HReq(s) and the HRply(t). The format contains a type value, an H bit, a N bit, an R bit, a M bit, a G bit, a T bit, a B bit, a lifetime value, a home area address of the MN, a home address of the MN, among which relevant to the present inventions are as follows: The type value indicates that the message is a handoff request (HReq) or a handoff reply (HRply). The H bit is a source-triggered hand off request. When the H bit is set, then the N bit is unset that indicates that the request is from a source. The N bit is a target triggered handoff request. When set and the H bit is unset, this is an indication that the request is from a target. In this embodiment, the oFA is sending the HReq. Thus, H is set and N is unset. The R bit is set if the request is a request to renew a tunnel when neither the H nor the N bits are set. The T bit indicates that the oFA is willing to support both forward and reverse tunnel service. Thus, the oFA may decide according policies whether to make the tunnel unidirectional or bidirectional. The B bit indicates that the MN has requested a reverse tunnel to the HA and that the nFA should use reverse tunnel to the HA if it will not be reverse tunneling to the oFA.

Next, the lifetime value indicates the time in seconds for which tunnel service for the MN will be maintained. If the lifetime value is zero and the T bit is not set, then the oFA is not willing to tunnel any packets for the MN. A positive lifetime value and a set T bit indicate that the oFA is willing to tunnel for the indicated time. The identification value is a 64 bit number utilized for matching registration requests with registration replies, and for protecting against replay attacks of registration messages.

As long as the L2 link remains up between oFA and MN, the oFA forwards to the MN data tunneled from the MN's HA, and tunnels back to the HA or sends out directly to the destination data received from the MN. When the link with the MN becomes down, the oFA, notified by a link down trigger, will start sending data received for MN to the nFA through the tunnel established between oFA and nFA. As soon as the MN enters the subnet operated by the nFA and an L2 link is established between MN and nFA, the nFA, notified by a link up trigger, will deliver to the MN data tunneled from the oFA and may tunnel data from the MN back to the oFA if the tunnel is bidirectional.

Thus, the above embodiment of the present invention allows the MN to utilize L2 triggers to set up a tunnel between oFA and nFA that allows the MN to continue using the oFA for data communication while on the nFA's subnet. This eliminates a possible source of handoff latency and enables a rapid establishment of service at the new point of attachment while minimizing the impact on real-time applications. The MN must eventually perform a formal Mobile IP registration illustrated in FIG. 2 after L2 communication with a new FA is established, but this can be delayed as required by the MN. Until the MN performs registration, a new FA and an old FA will setup and move a tunnel as required to give MN continued connectivity.

FIG. 3c illustrates a timing analysis of the Pre-MIT method operating under the trigger-less mode. Under this trigger-less mode, it is assumed that the oFA has a table storing the IP addresses and L2 identifiers of nearby FAs. These addresses are obtained in advance, using Router Solicitations and Router Advertisements defined in Mobile IPv4 (RFC 2002). The difference between the present invention and RFC 2002 is that in RFC 2002, these protocols are implemented between an MN and nearby FAs, whereas the same protocols are implemented between a FA and its neighboring FAs in the present invention. Thus, in this embodiment, the old FA sends out Agent Solicitations in advance to neighboring FAs. In response, the neighboring FAs return Agent Advertisements to the oFA. The oFA then extracts the L3 identifiers and L2 identifiers from extensions attached to the Advertisements and cashes them in the internal table.

It is also assumed under the trigger-less mode that no L2 trigger is available for MN to initiate the Pre-MIT. Therefore, the MN has to use its internal L2 signals to initiate the Pre-MIT. If the MN's L2 has the link evaluation capability, when it sees link degradation, it can notify the MN's L3 for handoff. Usually, MN's L2 is designed to be able to monitor the signal strengths of pilot beacons from nearby FAs including the one with which the MN is communicating. By monitoring the beacon signal strengths, the L2 can notify the L3 that an L2 handoff is imminent. The L2 may also provide prioritized possible new candidate FAs and their L2 identifiers in the notice to the L3. Alternatively, the MN may use L3 evaluation of packet latency to predict an L2 handoff. Such handoff prediction based on packet latency is described in U.S. patent application Ser. No. 09/770,544 entitled “MOBILITY PREDICTION IN WIRELESS, MOBILE ACCESS DIGITAL NETWORKS” by Gwon et al. and U.S. patent application Ser. No. 09/772,381 entitled “FAST DYNAMIC ROUTE ESTABLISHMENT IN WIRELESS, MOBILE ACCESS DIGITAL NETWORKS USING MOBILITY PREDICTION” by Gwon et al., both of which are hereby incorporated by reference.

Returning to FIG. 3c, while connected to the oFA, the MN monitors pilot beacons from the oFA and other nearby FAs to find candidate FAs for next handoff. The MN is traveling away from the oFA towards a new FA. There comes a point between oFA and nFA where the MN receives a notice from its L2 that the pilot beacon from the oFA is fading. Using this notification from the L2 as a trigger, the MN initiates the Pre-MIT (Step 301). It is assumed that the L2 has already notified the MN, based on the signal strength of received pilot beacons, that the nFA is the target of next handoff. When initiating the Pre-MIT, the MN attaches the L2 identifier of nFA to an Agent Solicitation and sends it to the oFA (Step 302).

When receiving the Agent Solicitation from the MN, the oFA opens the extension and extracts the L2 identifier from it. The oFA then searches the table for the IP address corresponding to the received L2 identifier and determines the IP address of nFA. The oFA then sends a HReq(s) to the nFA (Step 303). This HReq(s), as well as a HRply(t) sent in next Step 304, has the same data format as shown in FIG. 6. The operations performed in Step 304 and Step 305 in FIG. 3c are the same as those performed in the corresponding steps in FIG. 3b and therefore a detailed description thereof is omitted. Under the trigger-less mode, the MN is able to initiate the Pre-MIT without any assistance from other IP entities. Thus, the trigger-less mode is particularly suitable in situations where the hand-off is performed between FAs that support different radio access technologies. In some of the networks, e.g., IEEE 802.11x and Bluetooth, the L2 triggers as discussed above may not be available from the network side. According to the present invention, mobile nodes operating under the trigger-less mode can initiate the Pre-MIT between such heterogeneous networks irrespective of what radio access technologies these network supports.

FIG. 4a shows a Post-L2 handoff Mobile Initiated Tunneling Handoff (Post-MIT) scheme according to the present invention. FIG. 4b illustrates a timing analysis of the Post-MIT trigger mode scheme. FIG. 4c illustrates a timing analysis of the Post-MIT triggerless scheme. The difference between the Pre-MIT and the Post-MIT is that the Pre-MIT is initiated while the MN is within the oFA's subnet and has L2 connectivity to the oFA, whereas the Post-MIT is initiated after the MN enters the nFA's subnet (already lost L2 connectivity to the oFA) and establishes new L2 connectivity to the nFA. In other words, in the Pre-MIT, a tunnel between oFA and nFA is established while the MN is within the oFA's subnet before it begins an L2 handoff from the oFA to the nFA. In the Post-MIT, however, the tunnel is established after the MN enters the nFA″s subnet and the L2 handoff is completed to the nFA. Thus, the Pre-MIT may be characterized as “predictive” because a tunnel is established based on a predicted L2 handoff. The Post-MIT may be characterized as reactive because a tunnel is established subsequently to the establishment of new L2 connectivity to a new foreign agent.

The Post-MIT illustrated in FIG. 4b is initiated when the MN enters the subnet operated by the nFA. When leaving the oFA's subnet, the MN receives an L2 trigger informing that an L2 handoff is imminent, but the MN just ignores the trigger and let an L2 handoff take place. As soon as the MN enters the nFA's subnet, L2 connectivity is established between MN and nFA. The MN is notified of the fact by a link-up trigger (Step 401) and proceeds to initiate the Post-MIT. Alternatively, the MN may proceed with the standard Mobile IP registration process with the nFA. If the MN chooses to perform the standard registration process, the process will add to the handoff latency during which the MN will not be able to receive or send date until the registration process ends. If the MN was in the middle of sending or receiving delay sensitive data when the L3 connectivity to the oFA was lost, it should proceed with the Post-MIT according to the present invention.

Initiated by the link-up trigger, the MN sends the nFA a HReq(m) (Step 402) the data format of which is already shown in FIG. 5. The difference is that the HReq(m) used in the Pre-MIT method has an extension that contains the nFA's L2 identifier (L3 identifier is optional), whereas the HReq(m) used in the Post-MIT has an extension containing the oFA's IP address. When receiving the HReq(m), the nFA sends a HReq(t) to the oFA (Step 403). The oFA then returns a HRply(s) (Step 404). Through an exchange of the HReq(t) and the HRply(s) between nFA and oFA, a tunnel is established between them. The HRply(s) from the oFA is relayed to the MN from the nFA (Step 405) to notify the MN that a tunnel has been established. The HRply(s) from the oFA may be forwarded to the MN when the first data is sent to the MN through the tunnel. The HReq(t) and the HRply(s) are in the same message format as shown in FIG. 6. Since the HReq(t) is sent from the nFA (target) to the oFA (source), the H bit is unset and the N bit is set in the HReq(t). If the T bit is set in the HReq(t), the nFA is requesting reverse tunnel service. Also, a time indicated in the Lifetime represents a request by the nFA for a reverse tunnel. A value of 0 in the Lifetime indicates that the nFA does not require reverse tunnel service.

Using the tunnel between oFA and nFA, the MN, although being within the nFA's subnet, is able to receive data from the oFA. In the Post-MIT, the MN is not able to receive data until a tunnel is set up between nFA and oFA after it receives a link-up trigger. However, time for setting up the tunnel between nFA and oFA is considered minimal, compared to time required for the MN to perform the complete Mobile IP registration process in which registration request and reply messages propagate through intermediate networks between MN and its HA. Thus, like the Pre-MIT, the Post-MIT eliminates a possible source of handoff latency and enables a rapid establishment of service at the new point of attachment. The MN must eventually perform an L3 handoff somewhere, but this can be delayed as required by the MN.

FIG. 4c shows a time analysis of the Post-MIT operating under the triggerless mode. As in the Pre-MIT under the triggerless mode, no L2 trigger may be available for the MN to initiate the Post-MIT. Therefore, the MN must use its internal L2 signals to initiate the Post-MIT (Step 401). The MN's internal L2 signals that may be used for this purpose are internal link-up and link-down notifications generated from a protocol stack in the MN's link layer and brought up to the IP interface via an API by means of translating information available at the MN's device driver. Unlike the link-up or link-down trigger used in the trigger mode, these link-up and link-down notifications do not need to include any L2 or L3 identifier of the AP which the MN is connected to or disconnected from. For example, in wLAN IEEE 802.11b, the internal link-up and link-down notifications can be generated via a wLAN device driver when it receives a disassociation or re-association message created at the wLAN control frame.

Triggered by the internal L2 signal, the MN sends the nFA an Agent Solicitation with an extension containing the IP address of oFA (Step 402). The subsequent operations performed in Steps 403, 404 and 4055 are the same as the corresponding steps in FIG. 4b. This triggerless mode is particularly useful in situations where the Post-MIT is performed over heterogeneous networks that support different radio access technologies.

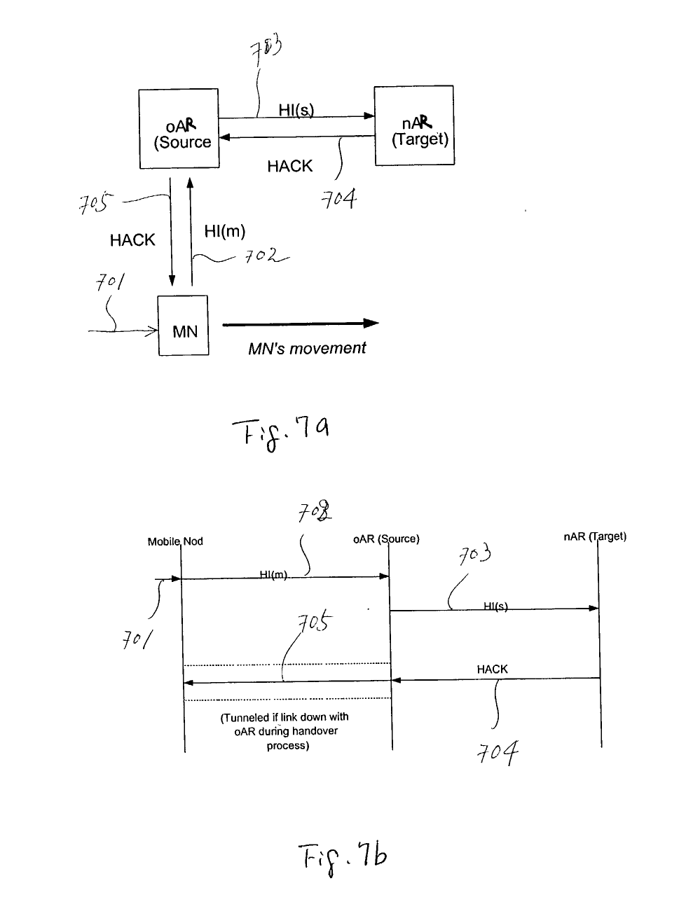

The present invention may also be used in networks that implement Mobile IPv6. FIGS. 7a and 7b are diagrams illustrating a Pre-L2 handoff Mobile Initiated Tunneling handoff (Pre-MIT) for Mobile IPv6 and its time analysis. There is no difference in basic protocols between the Pre-MIT for IPv6 and the counterpart for IPv4 already discussed above. The differences between them mainly reside in L3 messages used to implement the handoff operations. Like the Pre-MIT for IPv4, the Pre-MIT for IPv6 establishes a tunnel between an old access router (oAR) and a new access router (nAR) before an L2 handoff takes place from the oAR to the nAR. The tunnel so established will allow the MN to continue using the oAR for data communication while on the nAR's subnet. This eliminates a possible source of handoff latency and enables a rapid establishment of service at the new point of attachment while minimizing the impact on real-time applications.

Like the counterpart for IPv4, the Pre-MIT for IPv6 functions under either trigger or triggerless mode. Mobile IPv6 is designed to be more L2 independent than Mobile IPv4. But if the L2 trigger notifying that an L2 handoff is imminent is available in the IPv6 network, that L2 trigger may be used to trigger the MN to initiate the Pre-MIT according to this embodiment. If the L2 trigger is not available in the network, the Pre-MIT should be performed under the triggerless mode. Under the triggerless mode, if the MN has L2 capable of evaluating the link, the MN may use signaling from the L2 notifying link degradation. Alternatively, the MN may use L3 evaluation of packet latency to predict an L2 handoff.

As is required to implement the Pre-MIT for IPv4, the L2 identifier and/or L3 identifier of the nAR is also required to implement the Pre-MIT for IPv6. The MN can know the L2 identifier from beacon signals from the nAR. The MN can also know the L3 identifier from Router Advertisements from the nAR if the Router Advertisements reach the MN. The oAR may, on behalf of the MN, send Router Solicitations in advance to solicit Router Advertisements from the nearby ARs. When receiving Router Advertisements, the oAR cashes in a table the L3 identifiers of the nearby ARs in relation to their L2 identifiers. The table is used to identify the L3 identifier of the nAR when the MN notifies the oAR of only the L2 identifier of the nAR.

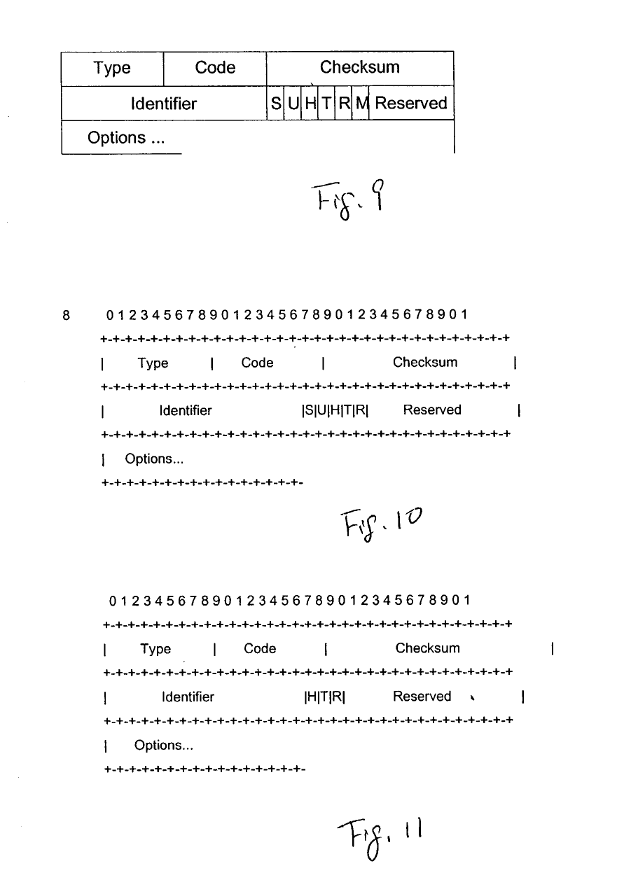

Returning to FIGS. 7a and 7b, triggered by either external or internal signaling that an L2 handoff is imminent (Step 701), the MN prepares a Mobile Handoff Initiation Message HI(m) and sends the HI(m) to the oAR (Step 702). This HI(m) is in a special message format that comprises an IP Field, an Internet Control Message Protocol (ICMP) Field and Option Field. The ICMP Field is shown in FIG. 9. The IP Field contains four values which provide parameters necessary to deliver a Handoff Initiation Message (HI) from a sender to a receiver. The first value in the IP Field is a Source Address, which is the MN's home IP address in this embodiment. The second value is a Destination Address, which is the oAR's IP address in this embodiment. The third value is a Hop Limit which is set to 255. The last value is an Authentication Header as required by IPv6 security protocol. This Authentication Header will be used to authenticate the HI to the receiver.

In the ICMP Field, the type value indicates that the message is a mobile handoff initiation message (HI(m)). The code value is 0. The checksum value is a 16-bit one's complement of the one's complement sum of the ICMP message, starting with the ICMP type value. The Identifier value indicates the sender of the message, which is the MN in this embodiment. The S bit is set to 0. The U bit is a buffer flag. When the U bit is set, until the MN becomes ready to receive data in the nAR'subnet, the nAR is required to buffer any packets destined for the MN that are tunneled from the oAR. The H bit is a Pre-MIT flag which indicates, when set, that the handoff operation is the Pre-MIT. The T bit is a Post-MIT flag, which indicates, when set, that the handoff operation is the Post-MIT. The R bit is set at 0. The M bit is a mobile initiation flag which indicates, when set, that the MN is initiating the MIT handoff. The Reserved value is set to 0.

There are five valid values that may be stored in the Option Field. The first value is the link layer (L2) address of the MN. This value should be included in the Field to help the destination recognize the MN. The second value is the link layer address of the nAR. The third value is the IP (L3) address of the nAR. In order to perform the Pre-MIT, either the link layer address or the IP address of the nAR has to be included in the Field to notify the oAR of the identity of the nAR, to which the MN is expecting to handoff. The forth value is the IP address of the oAR, which will be presented from the MN to the nAR when initiating the Post-MIT as discussed later. The last value is a new care of address (CoA) of MN. The MN's CoA includes nAR's IP address and a subnet address component for the MN as advertised by the nAR.

In FIGS. 7a and 7b, the HI(m) is sent to the nAR (Step 702). If the L3 identifier of the nAR is not included in the HI(m), the oAR searches the table for the L3 identifier corresponding to the L2 identifier of the nAR stored in the HI(m). The oAR then prepares a Source Handoff Initiation Message (HI(s)) and sends the HI(s) to the nAR (Step 703). The HI(s) is in a format that comprises an IP Field, ICMP Field and Option Field. The ICMP Field is illustrated in FIG. 10. In the IP Field, the Source Address is now the IP address of the oAR in this embodiment because the oAR is sending the HI(s). The Destination Address is set to the IP address of the nAR. The values in the ICMP Field are transported from the HI(m) sent from the MN. The Option Field includes: the link-layer address of the MN; the old CoA used by the MN while attached to the oAR; a new CoA that the MN wants to use when connected to the nAR; and a lifetime of a tunnel, in seconds, for which the oAR requests the tunnel to be maintained.

In response, the nAR returns a Handoff Acknowledgement Message (HACK) to the oAR (Step 704), whereby a bidirectional or unidirectional tunnel is established between oAR and nAR. The HACK is in a data format that comprises an IP Field, ICMP Field and an Option Field. The ICMP Field is shown in FIG. 11. In the IP Field, the Source Address is the IP address of the nAR. The Destination Address is set to the IP address of the oAR. In the ICMP Field, the code value may be set at one of “128,” “129” and “130” when the nAR cannot accept the handoff. The value “128” means to the receiver, i.e., the oAR, that the sender, i.e., the nAR, cannot accept the handoff for unspecified reasons. The value “129” means that the sender cannot accept the handoff because it is administratively prohibited. The value “130” means that the sender cannot accept the handoff because of insufficient resources. The Option Field includes a lifetime of a tunnel, in seconds, for which the sender, i.e., the nAR in this embodiment, is willing to grant tunnel service.

The HACK from the nAR is forwarded from the oAR to the MN (Step 705). If the MN finds any one of the above three values in the ICMP Field, the MN will perform the standard Mobile IPv6 registration process by sending out a Router Solicitation to find out candidate new access routers for handoff. If the MN fails to receive the HACK from the oAR within a certain period of time after it sent the HI(m) to the oAR, the MN will likewise proceed to perform the standard Mobile IPv6 registration process.

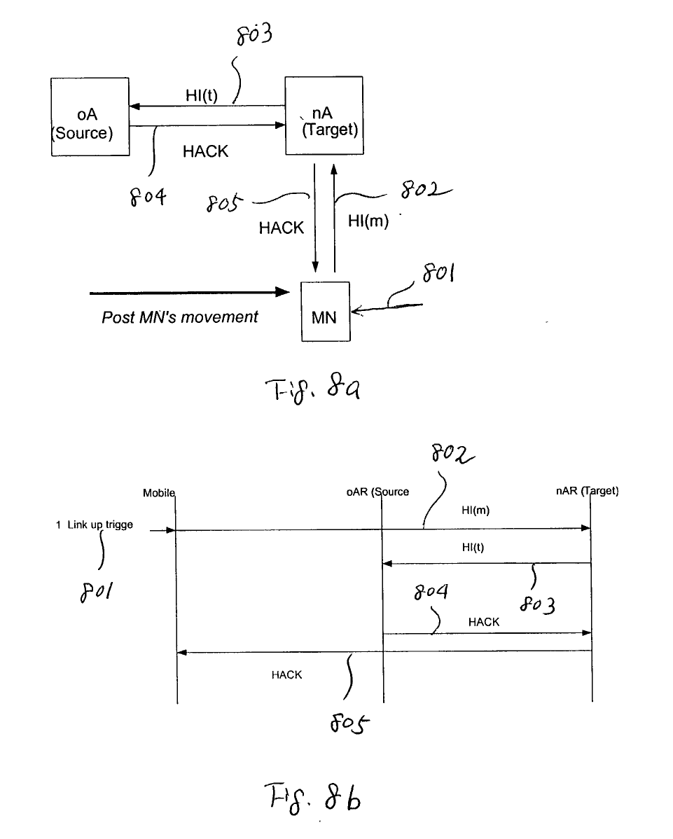

FIGS. 8a and 8b are diagrams illustrating a post-mobile initiated tunneling (Post-MIT) handoff for Mobile IPv6 and its time analysis. There is no difference in basic protocols between the Post-MIT for IPv6 and the counterpart for IPv4 already discussed above. The differences between them mainly reside in L3 messages used to implement the handoff operations. Like the counterpart for IPv4, the Post-MIT for IPv6 establishes a tunnel between an old access router (oAR) and a new access router (nAR) after new L2 connectivity is established between MN and nAR. The Post-MIT eliminates a possible source of handoff latency and enables a rapid establishment of service at the new point of attachment.

The Post-MIT illustrated in FIGS. 8a and 8b is initiated by the MN, as receiving a link-up trigger when the MN enters the subnet of nFA (Step 801). Initiated by the link-up trigger, the MN prepares a Mobile Handoff Initiation Message HI(m) and sends it to the nAR (Step 802). In the HI(m), the IP Field has the IP address of the nAR as the Destination Address. In the ICMP Field, the H bit is unset and the T bit is set. Instead of the link layer and/or IP address of the nAR, the Option Filed has the IP address of the oAR. Upon receipt of the HI(m) from the MN, the nAR prepares a Target Handoff Initiation Message (HI(t)) and sends it to the oAR (Step 803). The oAR returns a HACK to the nAR (Step 804), whereby a bi-directional or unidirectional tunnel is established between oAR and nAR. In the HI(t), the IP Field has the IP address of the nAR as the Source Address in this embodiment. The Destination Address is set to the IP address of the oAR. The values in the ICMP Field are transported from the HI(m) sent from the MN. The Option Field includes a lifetime of a tunnel, in seconds, for which the nAR requests the tunnel to be maintained.

In the HACK from the oAR, the IP Field has the IP address of the oAR as the Source Address in this embodiment. The Destination Address is set to the IP address of the nAR. In the ICMP Field, the code value may be set at one of “128,” “129” and “130” when the nAR cannot accept the handoff. These values have the same meanings as described above. The Option Field includes a lifetime of a tunnel, in seconds, for which the sender in this embodiment, i.e., the oAR, is willing to grant tunnel service.

The HACK from the nAR is forwarded from the oAR to the MN (Step 805). If the MN finds any one of the three values in the code, the MN will perform the standard Mobile IPv6 registration process with the nAR. Likewise, if the MN fails to receive the HACK from the oAR within a certain period of time after it sends the HI(m) to the nAR, the MN will proceeds to perform the standard Mobile IPv6 registration process.

It should be appreciated that the foregoing detailed description is illustrative rather than limiting, and that it is the following claims, including all equivalents, that are intended to define the spirit and scope of this invention. For instance, although only MN is the initiator of the Pre and Post MIT handoffs in the above embodiments, other IP entities, such as oFA (oAR), nFA (nAR) and even a radio access network located in the subnet operated by the oFA (oAR) or the subnet operated by the nFA (nAR), may initiate the handoffs of the present invention.

1. A method of implementing a low latency handoff by a mobile node between source and target nodes that support different radio access technologies, comprising the steps of:
triggering at least one of the mobile node, the source node and the target node to initiate the handoff process;
establishing, upon initiated, a tunnel between the source and target nodes; and
using the tunnel for data communication between the mobile node and the source node after the mobile node completes an L2 handoff from the source node to the target node but before undergoing IP routing update with the target node.

2. A method according to claim 1, wherein the mobile node is triggered to initiate the handoff process.

3. A method according to claim 2, wherein the mobile node, upon triggered, sends a tunneling handoff request to the source node.

4. A method according to claim 3, wherein the mobile node obtains an L2 identifier of the target node and includes the L2 identifier in the tunneling handoff request.

5. A method according to claim 4, wherein the source node creates a table containing L3 identifiers of neighboring networks in relation to their L2 identifiers and looks up the table for an L3 identifier that corresponds to the L2 identifier in the tunneling handoff request from the mobile node.

6. A method according to claim 3, wherein the mobile node obtains an L3 identifier of the target node and includes the L3 identifier in the tunneling handoff request.

7. A method according to claim 1, wherein the tunnel is established before the mobile node completes the L2 handoff between the source and target nodes.

8. A method according to claim 1, wherein the tunnel is established after the mobile node completes the L2 handoff between the source and target nodes.

9. A method according to claim 1, wherein the trigger is generated externally of the mobile node.

10. A method according to claim 1, wherein the trigger is generated internally of the mobile node.

11. A method according to claim 1, wherein the mobile node utilizes L2 signaling to initiate the handoff process.

12. A method according to claim 1, wherein the mobile node utilizes L2 signaling to initiate the handoff process.

13. A method according to claim 2, wherein the mobile node, upon triggered, sends a tunneling handoff request to the target node.

14. A method of implementing a low latency handoff by a mobile node between source and target nodes, comprising the steps of:
triggering the mobile node to initiate the handoff process;
establishing, upon initiated, a tunnel between the source and target nodes; and
using the tunnel for communication between the mobile node and source node after the mobile node completes an L2 handoff from the source node to the target node but before undergoing IP routing update with the target node.

15. A method according to claim 14, wherein the mobile node, upon triggered, sends a tunneling handoff request to the source node.

16. A method according to claim 15, wherein the mobile node obtains an L2 identifier of the target node and includes the L2 identifier in the tunneling handoff request.

17. A method according to claim 16, wherein the source node creates a table containing L3 identifiers of neighboring nodes in relation to their L2 identifiers and looks up the table for an L3 identifier that corresponds to the L2 identifier in the tunneling handoff request from the mobile node.

18. A method according to claim 15, wherein the mobile node obtains an L3 identifier of the target node and includes the L3 identifier in the tunneling handoff request.

19. A method according to claim 14, wherein the tunnel is established before the mobile node completes the L2 handoff from the source node to the target node.

20. A method according to claim 14, wherein the tunnel is established after the mobile node completes the L2 handoff from the source node to the target node.

21. A method according to claim 14, wherein the trigger is generated externally of the mobile node.

22. A method according to claim 14, wherein the trigger is generated internally of the mobile node.

23. A method according to claim 14, wherein the mobile node utilizes L2 signaling to initiate the handoff process.

24. A method according to claim 14, wherein the mobile node utilizes L3 signaling to initiate the handoff process.

25. A method according to claim 14, wherein the mobile node, upon triggered, sends a tunneling handoff request to the target node.

26. A mobile node that performs a low latency handoff between source and target nodes, comprising:
a controller that initiates the handoff upon triggered; and
a transmitter that sends, when the handoff is initiated, a tunneling handoff request to either the source or target node to establish a tunnel between the source and target nodes, wherein the tunnel is used for communication between the mobile node and the source node after the mobile node completes an L2 handoff from the source node to the target node but before undergoing IP routing update with the target node.

27. A mobile node according to claim 26, wherein the transmitter sends a tunneling handoff request to the source node.

28. A mobile node according to claim 27, wherein the mobile node comprises a receiver that obtains an L2 identifier of the target node, which will be included in the tunneling handoff request, wherein the source node has a table containing L3 identifiers of nearby nodes in relation to their L2 identifiers and looks up the table for a L3 identifier that corresponds to the L2 identifier in the tunneling handoff request from the mobile node.

29. A mobile node according to claim 27, wherein the mobile node comprises a receiver that obtains an L3 identifier of the target node, which will be included in the tunneling handoff request.

30. A mobile node according to claim 26, wherein the transmitter sends the tunneling handoff request before the mobile node completes an L2 handoff from the source node to the target node.

31. A mobile node according to claim 26, wherein the transmitter sends the tunneling handoff request after the mobile node completes an L2 handoff from the source node to the target node.

32. A mobile node according to claim 26, wherein the trigger is generated externally of the mobile node.

33. A mobile node according to claim 26, wherein the trigger is generated internally of the mobile node.

34. A mobile node according to claim 26, wherein the mobile node utilizes L2 signaling to initiate the handoff process.

35. A mobile node according to claim 26, wherein the mobile node utilizes L3 signaling to initiate the handoff process.

36. A mobile node according to claim 26, wherein the transmitter sends the tunneling handoff request to the target node.
